(19) United States
(12) Patent Application Publication
(10) Pub. No.: US 2024/0080135 A1
(43) Pub. Date: Mar. 7, 2024

(54) PUSCH REPETITION METHOD AND DEVICE

(71) Applicant: VIVO MOBILE COMMUNICATION CO., LTD., Dongguan (CN)

(72) Inventors: Xiaohang CHEN, Dongguan (CN); Xueming PAN, Dongguan (CN)

(73) Assignee: VIVO MOBILE COMMUNICATION CO., LTD., Dongguan (CN)

(21) Appl. No.: 18/506,999

(22) Filed: Nov. 10, 2023

Related U.S. Application Data
(63) Continuation of application No. PCT/CN2022/091822, filed on May 10, 2022.

(30) Foreign Application Priority Data
May 11, 2021 (CN) 202110513045.9

(51) Int. Cl. H04L 1/08; H04W 72/1268

(52) U.S. Cl. CPC H04L 1/08; H04W 72/1268

(57) ABSTRACT

A PUSCH repetition method and device are provided. The PUSCH repetition method includes: a network side device prohibits configuring enabling of a PUSCH uplink transmission skipping function for a terminal, and configure PUSCH repetitions of more than X times; or when the terminal is configured to enable the PUSCH uplink transmission skipping function and is configured to perform PUSCH repetitions of more than X times, prohibiting a resource conflict between scheduled or configured first UCI and a first transmission opportunity. The first transmission opportunity is the last Y transmission opportunities among K transmission opportunities. The PUSCH repetition includes the K transmission opportunities. K, X, and Y are all positive integers, K≥Y, and K is greater than or equal to 2.

### CROSS-REFERENCE TO RELATED APPLICATIONS

This application is a continuation of International Application No. PCT/CN2022/091822, filed May 10, 2022, which claims priority to Chinese Patent Application No. 202110513045.9, filed May 11, 2021. The entire contents of each of the above-referenced applications are expressly incorporated herein by reference.

### TECHNICAL FIELD

The present application relates to the technical field of communication, and in particular relates to a Physical Uplink Shared Channel (PUSCH) repetition method and device.

### BACKGROUND

In order to improve the reliability of transmission, a PUSCH can last for multiple time slots or symbols in the time domain, and perform repetitions in the time domain. At the same time, in order to reduce terminal overheads, a terminal can also enable an uplink transmission skipping (UL skipping) function of the PUSCH. When both the uplink transmission skipping function and the repetition function of the PUSCH are enabled, how to coordinate the uplink transmission skipping function and the repetition function of the PUSCH, so that the PUSCH can be effectively transmitted is a technical problem that needs to be solved urgently.

### SUMMARY

The embodiments of the present application provide a PUSCH repetition method and device.

According to a first aspect, a PUSCH repetition method is provided, including: prohibiting, by a network side device, configuring enabling of a physical uplink shared channel PUSCH uplink transmission skipping function for a terminal, and configuring PUSCH repetitions of more than X times; or in a case that the terminal is configured to enable the PUSCH uplink transmission skipping function and is configured to perform PUSCH repetitions of more than X times, prohibiting a resource conflict between scheduled or configured first uplink control information UCI and a first transmission opportunity, where the first transmission opportunity is the last Y transmission opportunities among K transmission opportunities; the PUSCH repetition includes the K transmission opportunities. K, X and Y are all positive integers, K≥Y, and K is greater than or equal to 2.

According to a second aspect, a PUSCH repetition method is provided, including: performing, by a terminal, PUSCH repetition including K transmission opportunities; where in a case that the terminal is configured to enable a PUSCH uplink transmission skipping function, the terminal does not expect configuration of PUSCH repetitions of more than X times; or in a case that the terminal is configured to enable the PUSCH uplink transmission skipping function, and is configured to perform PUSCH repetitions of more than X times, the terminal does not expect a resource conflict between first UCI and a first transmission opportunity, where the first transmission opportunity is the last Y transmission opportunity among K transmission opportunities; K, X and Y are all positive integers, K≥Y, and K is greater than or equal to 2.

According to a third aspect, a PUSCH repetition apparatus is provided, including: a configuration module, configured to prohibit configuring enabling of a PUSCH uplink transmission skipping function for a terminal, and configure PUSCH repetitions of more than X times; or in a case that the terminal is configured to enable the PUSCH uplink transmission skipping function and is configured to perform PUSCH repetitions of more than X times, prohibiting a resource conflict between scheduled or configured first UCI and a first transmission opportunity, where the first transmission opportunity is the last Y transmission opportunities among K transmission opportunities; the PUSCH repetition includes the K transmission opportunities, K, X and Y are all positive integers, K≥Y, and K is greater than or equal to 2.

According to a fourth aspect, a PUSCH repetition apparatus is provided, including: a sending module, configured to perform PUSCH repetition including K transmission opportunities; where in a case that the apparatus is configured to enable a PUSCH uplink transmission skipping function, the apparatus does not expect configuration of PUSCH repetitions of more than X times; or in a case that the apparatus is configured to enable the PUSCH uplink transmission skipping function, and is configured to perform PUSCH repetitions of more than X times, the apparatus does not expect a resource conflict between first UCI and a first transmission opportunity, where the first transmission opportunity is the last Y transmission opportunity among K transmission opportunities; K, X and Y are all positive integers, K≥Y, and K is greater than or equal to 2.

According to a fifth aspect, a terminal is provided, where the terminal includes a processor, a memory, and a program or an instruction stored in the memory and executable on the processor, where when the program or instruction is executed by the processor, the method according to the second aspect is implemented.

According to a sixth aspect, a terminal is provided, including: a processor and a communication interface, where the communication interface is configured to perform PUSCH repetition including K transmission opportunities; where in a case that the terminal is configured to enable a PUSCH uplink transmission skipping function, the terminal does not expect configuration of PUSCH repetitions of more than X times; or in a case that the terminal is configured to enable the PUSCH uplink transmission skipping function, and is configured to perform PUSCH repetitions of more than X times, the terminal does not expect a resource conflict between first UCI and a first transmission opportunity, where the first transmission opportunity is the last Y transmission opportunity among K transmission opportunities; K, X and Y are all positive integers, K≥Y, and K is greater than or equal to 2.

According to a seventh aspect, a network side device is provided. The network side device includes a processor, a memory, and a program or an instruction that is stored in the memory and that can be run on the processor, where when the program or the instruction is executed by the processor, the method in the first aspect is implemented.

According to an eighth aspect, a network side device is provided, including a processor and a communication interface, where the communication interface is configured to prohibit configuring enabling of a PUSCH uplink transmission skipping function for a terminal, and configure PUSCH repetitions of more than X times; or in a case that the terminal is configured to enable the PUSCH uplink transmission skipping function and is configured to perform PUSCH repetitions of more than X times, prohibiting a resource conflict between scheduled or configured first UCI and a first transmission opportunity, where the first transmission opportunity is the last Y transmission opportunities among K transmission opportunities; the PUSCH repetition includes the K transmission opportunities, K, X and Y are all positive integers, K≥Y, and K is greater than or equal to 2.

According to a ninth aspect, a readable storage medium is provided, where the readable storage medium stores a program or an instruction, and when the program or the instruction is executed by a processor, the method according to the first aspect or the second aspect is implemented.

According to a tenth aspect, a chip is provided. The chip includes a processor and a communication interface, the communication interface is coupled to the processor, and the processor is configured to run a program or an instruction to implement the method in the first aspect or the method in the second aspect.

According to an eleventh aspect, a computer program/program product is provided, where the computer program/program product is stored in a non-transient storage medium, and the program/program product is executed by at least one processor to implement the method as described in the first aspect or the method as described in the second aspect.

According to a twelfth aspect, a communication system is provided, including: a terminal and a network side device, the terminal can be configured to execute the method described in the first aspect, and the network side device can be configured to execute the method described in the second aspect.

The embodiment of the present application helps to keep the understanding of the network side equipment and the terminal consistent, and facilitate the effective transmission of a PUSCH; at the same time, helps to reduce the complexity of the terminal and reduce the resource consumption of the terminal; also helps to reduce the transmission delay of the PUSCH or the first UCI.

### BRIEF DESCRIPTION OF DRAWINGS

FIG. 1 is a schematic diagram of a wireless communications system according to an embodiment of this application;

FIG. 2 is a flowchart of a PUSCH repetition method according to an embodiment of the present application;

FIG. 3 is a flowchart of a PUSCH repetition method according to an embodiment of the present application;

FIG. 4 is a schematic structural diagram of a PUSCH repetition apparatus according to an embodiment of the present application;

FIG. 5 is a schematic structural diagram of a PUSCH repetition apparatus according to an embodiment of the present application;

FIG. 6 is a schematic diagram of a structure of a communications device according to an embodiment of this application;

FIG. 7 is a schematic diagram of a structure of a terminal according to an embodiment of this application; and

FIG. 8 is a schematic diagram of a structure of a network side device according to an embodiment of this application.

### DETAILED DESCRIPTION

The following clearly describes technical solutions in embodiments of this application with reference to accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the specification and the claims, “and/or” represents at least one of connected objects, and the character “/” generally represents an “or” relationship between associated objects.

It should be noted that, the technologies described in the embodiments of this application are not limited to a Long Term Evolution (LTE)/LTE-Advanced (LTE-A) system, and can also be used in other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and another system. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6^{th} generation (6G) communication system.

FIG. 1 is a schematic diagram of a wireless communications system to which an embodiment of this application can be applied. The wireless communications system includes a terminal 11 and a network side device 12. The terminal 11 may also be called a terminal device or User Equipment (UE), and the terminal 11 may be a mobile phone, a tablet personal computer, a laptop computer or a notebook computer, a Personal Digital Assistant (PDA), a palmtop computer, a netbook, an ultra-mobile personal computer (UMPC), a Mobile Internet Device (MID), a wearable device or a vehicle-mounted device (VUE), a pedestrian terminal (PUE), and other terminal side devices. The wearable device includes: smart watches, bracelets, earphones, glasses, etc. It should be noted that a specific type of the terminal 11 is not limited in the embodiments of this application. The network side device 12 may be a base station or a core network. A base station may be called a node B, an evolved node B, an access point, a base transceiver station (BTS), a radio base station, a radio transceiver, a basic service set (BSS), an extended service set (ESS), a Node B, an evolved Node B (eNB), a next-generation Node B (gNB), a home Node B, a home evolved Node B, a WLAN access point, a WiFi node, a transmitting and receiving point (TRP), or some other suitable term in the field, as long as the same technical effect is achieved. The base station is not limited to specific technical terms. It should be noted that in the embodiments of this application, only the base station in the NR system is taken as an example, but the specific type of the base station is not limited.

The PUSCH repetition method and device provided in the embodiments of the present application will be described in detail below through some embodiments and application scenarios with reference to the accompanying drawings.

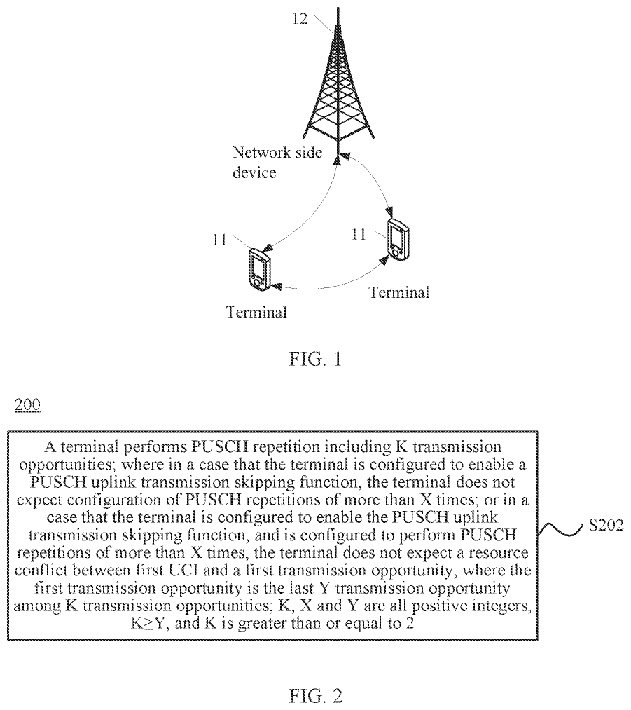

As shown in FIG. 2, the embodiment of the present application provides a Physical Uplink Shared Channel (PUSCH) repetition method 200, which can be executed by a terminal, in other words, the method can be implemented by software or hardware installed in the terminal. The method includes the following steps.

S202: A terminal performs PUSCH repetition including K transmission opportunities; where in a case that the terminal is configured to enable a PUSCH uplink transmission skipping function, the terminal does not expect configuration of PUSCH repetitions of more than X times; or in a case that the terminal is configured to enable the PUSCH uplink transmission skipping function, and is configured to perform PUSCH repetitions of more than X times, the terminal does not expect a resource conflict between first Uplink Control Information (UCI) and a first transmission opportunity, where the first transmission opportunity is the last Y transmission opportunity among K transmission opportunities; K, X and Y are all positive integers, K≥Y, and K is greater than or equal to 2.

In various embodiments of the present application, the first UCI may include at least one of the following: Hybrid Automatic Repeat request Acknowledgment (HARQ-ACK), Channel State Information (CSI), or a Scheduling Request (SR).

Embodiment 200 may include two technical solutions of method 1 and method 2, and the two technical solutions will be described respectively below.

### Method 1

In a case that the terminal is configured to enable a PUSCH uplink transmission skipping function, the terminal does not expect configuration of PUSCH repetitions of more than X times. In this way, the network side device can configure and enable the PUSCH uplink transmission skipping function for the terminal, and configure PUSCH repetitions less than or equal to X times.

In some embodiments, the data memory of the terminal has no data that needs to be transmitted via the PUSCH. In this way, when the terminal performs PUSCH repetitions including K transmission opportunities, it can also perform the PUSCH uplink transmission skipping function, that is, no Media Access Control Protocol Data Unit (MAC PDU) is generated for PUSCH repetitions of the K transmission opportunities.

When the data memory of the terminal has no data that needs to be transmitted via the PUSCH; or when the data memory of the terminal has data that needs to be transmitted via the PUSCH, that is, when the PUSCH uplink transmission skipping function is not enabled, if there is a resource conflict between the first Uplink Control Information (UCI) configured or scheduled by the network side device and any one of the K (K<X) transmission opportunities, the terminal can multiplex the first UCI on the PUSCH transmission opportunity where the resource conflict occurs for transmission, so that both the first UCI and the PUSCH can be effectively transmitted.

Considering that there is a resource conflict between the first UCI and any one of the K transmission opportunities, the terminal needs to check the PUSCH resources of the K transmission opportunities one by one. This embodiment limits the size of K, so that K<X. Compared with the technical solution of K≥X, it is beneficial to reduce the complexity of the terminal (checking PUSCH resources).

In addition, when the network side device instructs PUSCH repetition of the K transmission opportunities through a scheduling instruction (or configuration instruction), the time interval between the scheduling instruction and the first transmission opportunity usually needs to be greater than the processing time required to check PUSCH resources of the K transmission opportunities by the terminal. Considering that the larger K is, the longer the processing time required by the terminal to check the PUSCH resource, the time interval between the scheduling instruction and the first transmission opportunity also needs to be long enough. This embodiment limits the size of K, so that K<X. Compared to the technical solution of K≥X, it is beneficial to reduce the PUSCH transmission delay, that is, the time interval between the scheduling instruction and the first transmission opportunity can be set to be small enough to enable the terminal to check the PUSCH resources of the K transmission opportunities.

### Method 2

In a case that the terminal is configured to enable the PUSCH uplink transmission skipping function and is configured to perform PUSCH repetitions of more than X times, the terminal does not expect a resource conflict between the first UCI and a first transmission opportunity, where the first transmission opportunity is the last Y transmission opportunities among K transmission opportunities.

In some embodiments, the data memory of the terminal has no data that needs to be transmitted via the PUSCH. In this way, when the terminal performs PUSCH repetitions including K transmission opportunities, it can also perform the PUSCH uplink transmission skipping function, that is, no MAC PDU is generated for PUSCH repetitions of the K transmission opportunities.

In this embodiment, when the network side device configures enabling of the PUSCH uplink transmission skipping function for the terminal, and configures PUSCH repetitions of more than X times, the network side device can configure or schedule that the first UCI has a resource conflict with any one of the first (K-Y) transmission opportunities of the K (K≥X) transmission opportunities.

In this way, regardless of whether the terminal enables the PUSCH uplink transmission skipping function, the terminal can multiplex the first UCI on the PUSCH transmission opportunity where resource conflict occurs for transmission, so that both the first UCI and PUSCH can be effectively transmitted.

Considering that there is a resource conflict between the first UCI and any one of the K transmission opportunities, the terminal needs to check the PUSCH resources of these transmission opportunities one by one. In this embodiment, the position of the PUSCH resource where the resource conflict occurs is limited, so that it is located in the first (K-Y) transmission opportunities. Compared with the technical solution that the PUSCH resource where the resource conflict occurs is located in the last Y transmission opportunities, it is beneficial to reduce the complexity of terminals (checking the PUSCH resources).

In addition, when the network side device instructs the first UCI transmission through a scheduling instruction (or a configuration instruction), the scheduling instruction is usually located before K PUSCH transmission opportunities. In this embodiment, the position of the PUSCH resource where the resource conflict occurs is limited, so that it is located in the first (K-Y) transmission opportunities. Compared with the technical solution that the PUSCH resource where the resource conflict occurs is the last Y transmission opportunities, it is beneficial to reduce the transmission delay of the first UCI, that is, the time interval between the scheduling instruction and the first UCI is sufficiently small.

In the PUSCH repetition method provided in the embodiment of the present application, in a case that the terminal is configured to enable a PUSCH uplink transmission skipping function, the terminal does not expect configuration of PUSCH repetitions of more than X times; or in a case that the terminal is configured to enable the PUSCH uplink transmission skipping function, and is configured to perform PUSCH repetitions of more than X times, the terminal does not expect a resource conflict between first UCI and a first transmission opportunity, where the first transmission opportunity is the last Y transmission opportunity among K transmission opportunities. The embodiment of the present application helps to keep the understanding of the network side equipment and the terminal consistent, and facilitate the effective transmission of a PUSCH; at the same time, helps to reduce the complexity of the terminal and reduce the resource consumption of the terminal; also helps to reduce the transmission delay of the PUSCH or the first UCI.

In addition, the PUSCH repetition method provided by the embodiment of the present application can ensure the transmission of the first UCI by multiplexing the first UCI on the PUSCH transmission opportunity where the resource conflict occurs, and can avoid the blind detection of the network side device at the same time and improve the efficiency of transmission.

It should be noted that each embodiment of the present application is applicable to single carrier and multi-carrier, that is, PUSCH repetition and PUSCH can be on the same carrier or different carriers; it is also applicable to licensed frequency bands or unlicensed frequency bands.

In order to describe the PUSCH repetition provided by the embodiment of the present application in detail, the following will describe in conjunction with two specific embodiments. In the following two embodiments, the terminal enables the uplink transmission skipping (UL skipping) function of the PUSCH, PUSCH repetition is configured, and the number of repetitions is K, where K≥1.

### Embodiment 1

Embodiment 1 mainly corresponds to the method 1 above. In this embodiment, in a case that the terminal is configured to enable a PUSCH uplink transmission skipping function, the terminal does not expect configuration of PUSCH repetitions of more than X times.

In this embodiment, X may be a value predefined or configured by the network side device, for example, X=2, 3, 4, or the like.

In this embodiment, the PUSCH repetition includes type A repetition (PUSCH repetition type A), and the network side device configures enabling of the PUSCH uplink transmission skipping function for the terminal, and configures PUSCH repetitions less than or equal to X times or configures a time domain resource allocation list less than or equal to X; or
the PUSCH repetition includes type B repetition (PUSCH repetition type B), and the network side device configures enabling of the PUSCH uplink transmission skipping function for the terminal, and configures a time domain resource allocation list less than or equal to X.

For example, for PUSCH repetition type A, the UE does not expect the network side device to configure enabling of the UL skipping function, and the network configures repetition, where K>X or configures a time domain resource allocation list (TimeDomainAllocationList), where K>X.

For PUSCH repetition type B, the UE does not expect the network side device to configure enabling of the UL skipping function, and a time domain resource allocation list (TimeDomainAllocationList) is configured, where K>X.

In other words, the network side device can configure that the UE enables UL skipping, and configure PUSCH repetition with K≤X. When there is a resource conflict between the first UCI and a transmission opportunity of any PUSCH repetition, the UE can multiplex the first UCI on the PUSCH repetition of the resource conflict, and the Media Access Control (MAC) generates a Media Access Control Protocol Data Unit (MAC PDU) for the PUSCH repetition.

In some embodiments, the method further includes: receiving first information, where the first information is used to schedule or configure first UCI transmission, the first UCI has a resource conflict with a second transmission opportunity, and the second transmission opportunity is any one of the K transmission opportunities; and multiplexing the first UCI on the PUSCH of the second transmission opportunity for transmission; or transmitting the first UCI on a Physical Uplink Control Channel (PUCCH). The PUCCH may partially or fully overlap with the PUSCH of the second transmission opportunity in the time domain, and does not overlap with it in the frequency domain.

### Embodiment 2

In a case that the terminal is configured to enable the PUSCH uplink transmission skipping function and is configured to perform PUSCH repetitions of more than X times, the terminal does not expect a resource conflict between the first UCI and a first transmission opportunity, where the first transmission opportunity is the last Y transmission opportunities among K transmission opportunities.

In this embodiment, Y may or may not be equal to X. X and Y may be values predefined or configured by the network side device, for example, X=2, 3, 4, or the like; Y=2, 3, 4, or the like.

In this embodiment, the PUSCH repetition includes type A repetition, and the network side device configures enabling of the PUSCH uplink transmission skipping function for the terminal, and configures PUSCH repetitions of more than X times.

The PUSCH repetition includes type A repetition, the network side device configures enabling of the PUSCH uplink transmission skipping function for the terminal, configures a time domain resource allocation list greater than X, and the terminal is scheduled to perform PUSCH repetitions greater than X times.

The PUSCH repetition includes type B repetition, the network side device configures enabling of the PUSCH uplink transmission skipping function for the terminal, configures a time domain resource allocation list greater than X, and the terminal is scheduled to perform PUSCH repetitions greater than X times.

In some embodiments, for PUSCH repetition type A, the network configures enabling of the UL skipping function, the network configures repetition with K>X, the UE does not expect to be scheduled with a resource conflict between the first UCI and the first PUSCH transmission opportunity, and the first PUSCH transmission opportunity is the last Y transmission opportunities of the K repetitions.

For PUSCH repetition type A, the network configures enabling of the UL skipping function, and the network configures a time domain resource allocation list (TimeDomainAllocationList) with K>X, the UE does not expect to be scheduled for K>X repetitions and scheduled/configured with a resource conflict between the first UCI and the first PUSCH transmission opportunity, and the first PUSCH transmission opportunity is the last Y transmission opportunities of the K repetitions.

For PUSCH repetition type B, the network configures enabling of the UL skipping function, and the network configures a time domain resource allocation list (TimeDomainAllocationList) with K>X, the UE does not expect to be scheduled for K>X repetitions and scheduled/configured with a resource conflict between the first UCI and the first PUSCH transmission opportunity, and the first PUSCH transmission opportunity is the last Y transmission opportunities of the K repetitions.

In other words, when the network configures that the UE enables UL skipping, and configures PUSCH repetition with K>X, when there is a resource conflict between the first UCI and a transmission opportunity of any one of the previous (K-Y) PUSCH repetitions, the UE can multiplex the first UCI on the PUSCH repetition of the resource conflict, and the MAC generates a PDU for the PUSCH repetition.

In some embodiments, the method further includes: receiving first information, where the first information is used to schedule or configure first UCI transmission, the first UCI has a resource conflict with a second transmission opportunity, and the second transmission opportunity is any one of the first (K-Y) transmission opportunities of the K transmission opportunities; and multiplexing the first UCI on the PUSCH of the second transmission opportunity for transmission; or transmitting the first UCI on a physical uplink control channel PUCCH.

For each of the foregoing embodiments, at least one of the following three conditions is satisfied:
1) The first UCI may be dynamically scheduled or semi-statically configured, and the first UCI includes at least one of the following: a HARQ-ACK, CSI, or an SR.
2) PUSCH can be dynamically scheduled PUSCH or semi-statically configured PUSCH (such as configured grant).
3) The priorities of the first UCI and the conflicting PUSCH may be the same or different.

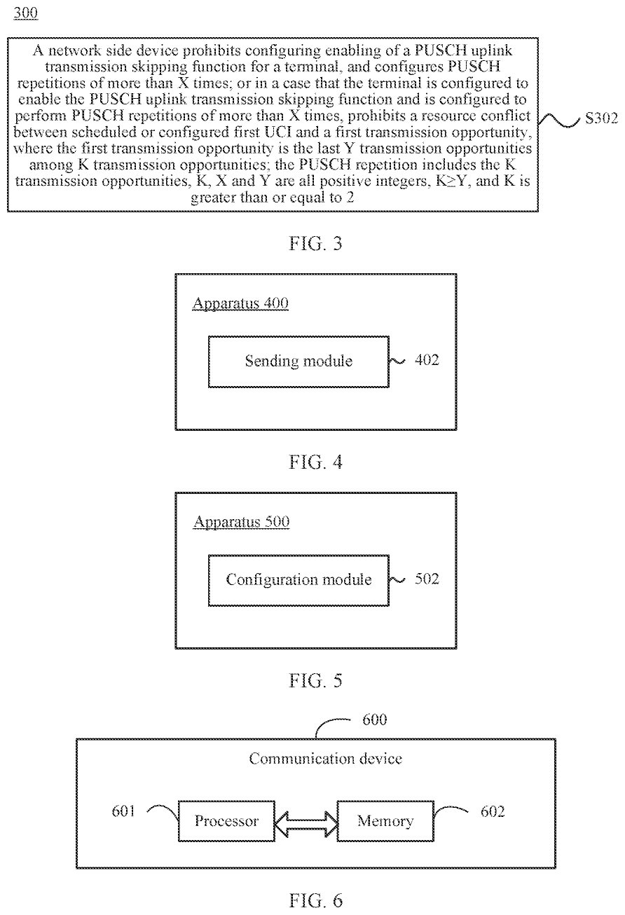

The PUSCH repetition method according to the embodiment of the present application has been described in detail above with reference to FIG. 2. A PUSCH repetition method according to another embodiment of the present application will be described in detail below with reference to FIG. 3. It can be understood that interaction between a network side device and a terminal described from the perspective of the network side device is the same as that described on the terminal side in the method shown in FIG. 2. To avoid repetition, related descriptions are appropriately omitted.

FIG. 3 is a schematic diagram of the implementation flow of the PUSCH repetition method according to the embodiment of the present application, which can be applied to a network side device. As shown in FIG. 3, the method 300 includes the following steps.

S302: A network side device prohibits configuring enabling of a PUSCH uplink transmission skipping function for a terminal, and configure PUSCH repetitions of more than X times; or in a case that the terminal is configured to enable the PUSCH uplink transmission skipping function and is configured to perform PUSCH repetitions of more than X times, prohibiting a resource conflict between scheduled or configured first UCI and a first transmission opportunity, where the first transmission opportunity is the last Y transmission opportunities among K transmission opportunities; the PUSCH repetition includes the K transmission opportunities, K, X and Y are all positive integers, K≥Y, and K is greater than or equal to 2.

In this embodiment, for example, the network side device may send second information to the terminal. The second information may be configuration information or scheduling information. The second information is used to configure that the terminal enables the PUSCH uplink transmission skipping function, and configure that the terminal performs PUSCH repetitions less than or equal to X times.

It should be noted that, in fact, the network side device can respectively configure, through different configuration information, that the terminal enables the PUSCH uplink transmission skipping function and configure that the terminal performs PUSCH repetition less than or equal to X times. For the convenience of description, in this embodiment, these pieces of information are collectively referred to as second information.

In this embodiment, for another example, when it is configured that the terminal enables the PUSCH uplink transmission skipping function, and it is configured that PUSCH repetitions of more than X times are performed, the network side device may send third information to the terminal, and the third information may be configuration information or scheduling information, the third information is used to schedule or configure transmission of the first UCI, and the first UCI has a resource conflict with any one of the first (K-Y) transmission opportunities of the K (K≥X) transmission opportunities.

The embodiment of the present application helps to keep the understanding of the network side equipment and the terminal consistent, and facilitate the effective transmission of a PUSCH; at the same time, helps to reduce the complexity of the terminal and reduce the resource consumption of the terminal; also helps to reduce the transmission delay of the PUSCH or the first UCI.

In some embodiments, the PUSCH repetition includes type A repetition, and the network side device configures enabling of the PUSCH uplink transmission skipping function for the terminal, and configures PUSCH repetitions less than or equal to X times or configures a time domain resource allocation list less than or equal to X; or the PUSCH repetition includes type B repetition, and the network side device configures enabling of the PUSCH uplink transmission skipping function for the terminal, and configures a time domain resource allocation list less than or equal to X.

In some embodiments, the method further includes: sending first information, where the first information is used to schedule or configure transmission of the first UCI, the first UCI and the second transmission opportunity have a resource conflict, and the second transmission opportunity is any one of the K transmission opportunities; and receiving a PUSCH of the second transmission opportunity, where the PUSCH of the second transmission opportunity includes the first UCI.

In some embodiments, the PUSCH repetition includes type A repetition, and the network side device configures enabling of the PUSCH uplink transmission skipping function for the terminal, and configures PUSCH repetitions of more than X times; the PUSCH repetition includes type A repetition, the network side device configures enabling of the PUSCH uplink transmission skipping function for the terminal, and configures a time domain resource allocation list greater than X, and the terminal is scheduled to perform PUSCH repetitions greater than X times; or the PUSCH repetition includes type B repetition, the network side device configures enabling of the PUSCH uplink transmission skipping function for the terminal, configures a time domain resource allocation list greater than X, and the terminal is scheduled to perform PUSCH repetitions greater than X times.

In some embodiments, the method further includes: sending first information, where the first information is used to schedule or configure the transmission of the first UCI, and the first UCI and the second transmission may have a resource conflict, and the second transmission opportunity is any one of the first (K-Y) transmission opportunities among the K transmission opportunities; and receiving a PUSCH of the second transmission opportunity, where the PUSCH of the second transmission opportunity includes the first UCI.

In some embodiments, the first UCI includes at least one of the following: a HARQ-ACK, CSI, or an SR.

It should be noted that, the PUSCH repetition method provided in the embodiment of the present application may be executed by a PUSCH repetition apparatus, or a control module in the PUSCH repetition apparatus for executing the PUSCH repetition method. In the embodiment of the present application, the PUSCH repetition method performed by the PUSCH repetition apparatus is taken as an example to describe the PUSCH repetition apparatus provided in the embodiment of the present application.

FIG. 4 is a schematic structural diagram of a PUSCH repetition apparatus according to an embodiment of the present application, and the apparatus may correspond to a terminal in other embodiments. As shown in FIG. 4, an apparatus 400 includes the following modules:
a sending module 402, configured to perform PUSCH repetition including K transmission opportunities; where in a case that the apparatus is configured to enable a PUSCH uplink transmission skipping function, the apparatus does not expect configuration of PUSCH repetitions of more than X times; or in a case that the apparatus is configured to enable the PUSCH uplink transmission skipping function, and is configured to perform PUSCH repetitions of more than X times, the apparatus does not expect a resource conflict between first UCI and a first transmission opportunity, where the first transmission opportunity is the last Y transmission opportunity among K transmission opportunities; K, X and Y are all positive integers, K≥Y, and K is greater than or equal to 2.

The embodiment of the present application helps to keep the understanding of the network side equipment and the apparatus 400 consistent, and facilitate the effective transmission of a PUSCH; at the same time, helps to reduce the complexity of the apparatus 400 and reduce the resource consumption of the apparatus 400; also helps to reduce the transmission delay of the PUSCH or the first UCI.

In some embodiments, the PUSCH repetition includes type A repetition, and the network side device configures enabling of the PUSCH uplink transmission skipping function for the apparatus, and configures PUSCH repetitions less than or equal to X times or configures a time domain resource allocation list less than or equal to X; or the PUSCH repetition includes type B repetition, and the network side device configures enabling of the PUSCH uplink transmission skipping function for the apparatus, and configures a time domain resource allocation list less than or equal to X.

In some embodiments, the apparatus further includes: a receiving module, configured to receive first information, where the first information is used to schedule or configure first UCI transmission, the first UCI has a resource conflict with a second transmission opportunity, and the second transmission opportunity is any one of the K transmission opportunities; and the sending module 402 is further configured to multiplex the first UCI on the PUSCH of the second transmission opportunity for transmission; or transmit the first UCI on a physical uplink control channel PUCCH.

In some embodiments, the PUSCH repetition includes type A repetition, and the network side device configures enabling of the PUSCH uplink transmission skipping function for the apparatus, and configures PUSCH repetitions of more than X times; the PUSCH repetition includes type A repetition, the network side device configures enabling of the PUSCH uplink transmission skipping function for the apparatus, and configures a time domain resource allocation list greater than X, and the apparatus is scheduled to perform PUSCH repetitions greater than X times; or the PUSCH repetition includes type B repetition, the network side device configures enabling of the PUSCH uplink transmission skipping function for the apparatus, configures a time domain resource allocation list greater than X, and the apparatus is scheduled to perform PUSCH repetitions greater than X times.

In some embodiments, the apparatus further includes: a receiving module, configured to receive first information, where the first information is used to schedule or configure first UCI transmission, the first UCI has a resource conflict with a second transmission opportunity, and the second transmission opportunity is any one of the first (K-Y) transmission opportunities of the K transmission opportunities; and the sending module 402 is further configured to multiplex the first UCI on the PUSCH of the second transmission opportunity for transmission; or transmit the first UCI on a physical uplink control channel PUCCH.

In some embodiments, the data memory of the device has no data that needs to be transmitted via the PUSCH.

The apparatus 400 according to the embodiments of this application may correspond to the procedures of the method 200 in the embodiments of this application, and the units/modules in the apparatus 400 and the foregoing operations and/or functions are respectively for implementing the corresponding procedures of the method 200 and can achieve a same or equivalent technical effect. For brevity, details are not described herein again.

The PUSCH repetition apparatus in the embodiment of the present application may be an apparatus, an apparatus with an operating system or an electronic device, or it may be a component, an integrated circuit, or a chip in a terminal. The apparatus or electronic device may be a mobile terminal, or a non-mobile terminal. For example, the mobile terminal may include but is not limited to the foregoing listed types of terminals 11. The non-mobile terminal may be a server, a Network Attached Storage (NAS), a personal computer (PC), a television (TV), a teller machine, or a self-service machine. This is not specifically limited in this embodiment of this application.

The PUSCH repetition apparatus according to the embodiment of the present disclosure can implement the processes in the method embodiments in FIG. 2 to FIG. 3, and achieve the same technical effect. To avoid duplication, details are not described herein again.

FIG. 5 is a schematic structural diagram of a PUSCH repetition apparatus according to an embodiment of the present application, and the apparatus may correspond to a network side device in other embodiments. As shown in FIG. 5, an apparatus 500 includes the following modules:
a configuration module 502, configured to prohibit configuring enabling of a PUSCH uplink transmission skipping function for a terminal, and configure PUSCH repetitions of more than X times; or in a case that the terminal is configured to enable the PUSCH uplink transmission skipping function and is configured to perform PUSCH repetitions of more than X times, prohibiting a resource conflict between scheduled or configured first UCI and a first transmission opportunity, where the first transmission opportunity is the last Y transmission opportunities among K transmission opportunities; the PUSCH repetition includes the K transmission opportunities, K, X and Y are all positive integers, K≥Y, and K is greater than or equal to 2.

The embodiment of the present application helps to keep the understanding of the apparatus 500 and the terminal consistent, and facilitate the effective transmission of a PUSCH; at the same time, helps to reduce the complexity of the terminal and reduce the resource consumption of the terminal; also helps to reduce the transmission delay of the PUSCH or the first UCI.

In some embodiments, the PUSCH repetition includes type A repetition, and the configuration module 502 is configured to configure enabling of the PUSCH uplink transmission skipping function for the terminal, and configure PUSCH repetitions less than or equal to X times or configure a time domain resource allocation list less than or equal to X; or the PUSCH repetition includes type B repetition, and the configuration module 502 is configured to configure enabling of the PUSCH uplink transmission skipping function for the terminal, and configure a time domain resource allocation list less than or equal to X.

In some embodiments, the apparatus further includes: a sending module, configured to send first information, where the first information is used to schedule or configure transmission of first UCI, and the first UCI and the second transmission opportunity have a resource conflict, and the second transmission opportunity is any one of the K transmission opportunities; the receiving module is configured to receive the PUSCH of the second transmission opportunity, where the PUSCH of the second transmission opportunity includes the first UCI.

In some embodiments, the PUSCH repetition includes type A repetition, and the configuration module 502 is configured to configure enabling of the PUSCH uplink transmission skipping function for the terminal, and configure PUSCH repetitions of more than X times; the PUSCH repetition includes type A repetition, the configuration module 502 is configured to configure enabling of the PUSCH uplink transmission skipping function for the terminal, and configure a time domain resource allocation list greater than X, and the terminal is scheduled to perform PUSCH repetitions greater than X times; or the PUSCH repetition includes type B repetition, the configuration module 502 is configured to configure enabling of the PUSCH uplink transmission skipping function for the terminal, and configure a time domain resource allocation list greater than X, and the terminal is scheduled to perform PUSCH repetitions greater than X times.

In some embodiments, the apparatus further includes: a sending module, configured to send first information, where the first information is used to schedule or configure the transmission of the first UCI, and the first UCI and the second transmission may have a resource conflict, and the second transmission opportunity is any one of the first (K-Y) transmission opportunities among the K transmission opportunities; and a receiving module, configured to receive a PUSCH of the second transmission opportunity, where the PUSCH of the second transmission opportunity includes the first UCI.

The apparatus 500 according to the embodiments of this application may correspond to the procedures of the method 300 in the embodiments of this application, and the units/modules in the apparatus 500 and the foregoing operations and/or functions are respectively for implementing the corresponding procedures of the method 300 and can achieve a same or equivalent technical effect. For brevity, details are not described herein again.

As shown in FIG. 6, an embodiment of the present application further provides a communication device 600, including a processor 601, a memory 602, and a program or an instruction stored in the memory 602 and executable on the processor 601. For example, when the communication device 600 is a terminal, when the program or instruction is executed by the processor 601, each process of the embodiment of the foregoing PUSCH repetition method is performed, and the same technical effect can be achieved. When the communication device 600 is a network side device, when the programs or instructions are executed by the processor 601, each process of the above embodiment of the PUSCH repetition method is performed, and the same technical effect can be achieved. To avoid repetition, details are not repeated herein.

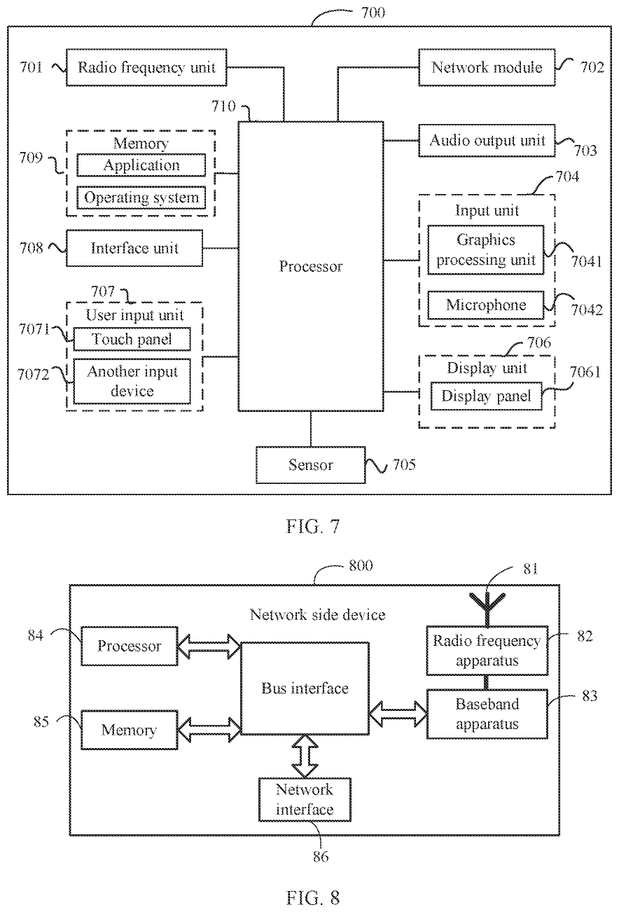

The embodiment of the present application also provides a terminal, including: a processor and a communication interface, where the communication interface is configured to perform PUSCH repetition including K transmission opportunities; where in a case that the terminal is configured to enable a PUSCH uplink transmission skipping function, the terminal does not expect configuration of PUSCH repetitions of more than X times; or in a case that the terminal is configured to enable the PUSCH uplink transmission skipping function, and is configured to perform PUSCH repetitions of more than X times, the terminal does not expect a resource conflict between first UCI and a first transmission opportunity, where the first transmission opportunity is the last Y transmission opportunity among K transmission opportunities; K, X and Y are all positive integers, K≥Y, and K is greater than or equal to 2. This terminal embodiment corresponds to the foregoing method embodiment on the terminal side. Each implementation process and implementation of the foregoing method embodiment may be applicable to this terminal embodiment, and a same technical effect can be achieved. FIG. 7 is a schematic diagram of a hardware structure of a terminal according to an embodiment of this application.

A terminal 700 includes but is not limited to at least a part of components such as a radio frequency unit 701, a network module 702, an audio output unit 703, an input unit 704, a sensor 705, a display unit 706, a user input unit 707, an interface unit 708, a memory 709, and a processor 710.

A person skilled in the art can understand that the terminal 700 may further include a power supply (such as a battery) that supplies power to each component. The power supply may be logically connected to the processor 710 by using a power supply management system, to implement functions such as charging and discharging management, and power consumption management by using the power supply management system. The terminal structure shown in FIG. 7 constitutes no limitation on the terminal, and the terminal may include more or fewer components than those shown in the figure, or combine some components, or have different component arrangements. Details are not described herein.

It should be understood that, in the embodiments of this application, the input unit 704 may include a Graphics Processing Unit (GPU) 7041 and a microphone 7042, and the graphics processing unit 7041 processes image data of a still picture or video obtained by an image capture apparatus (such as a camera) in a video capture mode or an image capture mode. The display unit 706 may include a display panel 7061. In some embodiments, the display panel 7061 may be configured in a form such as a liquid crystal display or an organic light-emitting diode. The user input unit 707 includes a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, the radio frequency unit 701 receives downlink data from a network side device and then sends the downlink data to the processor 710 for processing; and sends uplink data to the network side device. Usually, the radio frequency unit 701 includes but is not limited to an antenna, at least one amplifier, a transceiver, a coupler, a low noise amplifier, a duplexer, and the like.

The memory 709 may be configured to store a software program or an instruction and various data. The memory 709 may mainly include a program or instruction storage area and a data storage area. The program or instruction storage area may store an operating system, and an application or an instruction required by at least one function (for example, a sound playing function or an image playing function). In addition, the memory 709 may include a high-speed random access memory and non-transient memory. The non-transient memory may be a Read-only Memory (ROM), a Programmable ROM (PROM), an Erasable PROM (EPROM), an Electrically EPROM (EEPROM), or a flash memory, for example, at least one disk storage component, a flash memory component, or another non-transient solid-state storage component.

The processor 710 may include one or more processing units. In some embodiments, an application processor and a modem processor may be integrated into the processor 710. The application processor mainly processes an operating system, a user interface, an application, an instruction, or the like. The modem processor mainly processes wireless communication, for example, a baseband processor. It can be understood that, the modem processor may not be integrated into the processor 710.

The radio frequency unit 701 may be configured to perform PUSCH repetition including K transmission opportunities; where in a case that the terminal is configured to enable a PUSCH uplink transmission skipping function, the terminal does not expect configuration of PUSCH repetitions of more than X times; or in a case that the terminal is configured to enable the PUSCH uplink transmission skipping function, and is configured to perform PUSCH repetitions of more than X times, the terminal does not expect a resource conflict between first UCI and a first transmission opportunity, where the first transmission opportunity is the last Y transmission opportunity among K transmission opportunities; K, X and Y are all positive integers, K≥Y, and K is greater than or equal to 2.

The embodiment of the present application helps to keep the understanding of the network side equipment and the terminal consistent, and facilitate the effective transmission of a PUSCH; at the same time, helps to reduce the complexity of the terminal and reduce the resource consumption of the terminal; also helps to reduce the transmission delay of the PUSCH or the first UCI.

The terminal 700 provided in the embodiment of the present application can also implement the processes of the PUSCH repetition method embodiment described above, and can achieve the same technical effect. To avoid repetition, details are not repeated here.

The embodiment of the present application also provides a network side device, including a processor and a communication interface, where the communication interface is configured to prohibit configuring enabling of a PUSCH uplink transmission skipping function for a terminal, and configure PUSCH repetitions of more than X times; or in a case that the terminal is configured to enable the PUSCH uplink transmission skipping function and is configured to perform PUSCH repetitions of more than X times, prohibiting a resource conflict between scheduled or configured first UCI and a first transmission opportunity, where the first transmission opportunity is the last Y transmission opportunities among K transmission opportunities; the PUSCH repetition includes the K transmission opportunities, K, X and Y are all positive integers, K≥Y, and K is greater than or equal to 2. This network side device embodiment corresponds to the foregoing method embodiment on the network side device. Each implementation process and implementation of the foregoing method embodiment may be applicable to this network side device embodiment, and a same technical effect can be achieved.

An embodiment of this application further provides a network side device. As shown in FIG. 8, a network side device 800 includes an antenna 81, a radio frequency apparatus 82, and a baseband apparatus 83. The antenna 81 is connected to the radio frequency apparatus 82. In an uplink direction, the radio frequency apparatus 82 receives information by using the antenna 81, and sends the received information to the baseband apparatus 83 for processing. In a downlink direction, the baseband apparatus 83 processes to-be-sent information, and sends the information to the radio frequency apparatus 82. The radio frequency apparatus 82 processes the received information and then sends the information by using the antenna 81.

The foregoing band processing apparatus may be located in the baseband apparatus 83. In the foregoing embodiment, a method performed by the network side device may be implemented in the baseband apparatus 83. The baseband apparatus 83 includes a processor 84 and a memory 85.

The baseband apparatus 83 may include, for example, at least one baseband board, where a plurality of chips are disposed on the baseband board. As shown in FIG. 8, one chip is, for example, the processor 84, which is connected to the memory 85, so as to invoke a program in the memory 85 to perform operations of the network side device shown in the foregoing method embodiment.

The baseband apparatus 83 may further include a network interface 86, configured to exchange information with the radio frequency apparatus 82. For example, the interface is a common public radio interface (CPRI).

The network side device in this embodiment of this application further includes an instruction or a program that is stored in the memory 85 and that can be run on the processor 84. The processor 84 invokes the instruction or the program in the memory 85 to perform the method performed by the modules shown in FIG. 5, and a same technical effect is achieved. To avoid repetition, details are not described herein again.

An embodiment of the present application further provides a readable storage medium. The readable storage medium stores a program or an instruction, and when the program or the instruction is executed by a processor, the various processes of the foregoing PUSCH repetition method embodiment is performed and the same technical effects can be achieved. To avoid repetition, details are not described herein again.

The processor is the processor in the terminal described in the above embodiment. The readable storage medium includes a computer-readable storage medium, such as a computer Read-only Memory (ROM), a Random Access Memory (RAM), a magnetic disk, or an optical disc.

An embodiment of the present application further provides a chip, the chip includes a processor and a communication interface, the communication interface is coupled to the processor, and the processor is configured to run programs or instructions to implement each process of the embodiment of the foregoing PUSCH repetition method and the same technical effects can be achieved. To avoid repetition, details are not described herein again.

It should be understood that the chip mentioned in this embodiment of this application may also be referred to as a system-level chip, a system chip, a chip system, or an on-chip system chip.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to such process, method, article, or apparatus. In the absence of more restrictions, an element defined by the statement “including a . . . ” does not exclude another same element in a process, method, article, or apparatus that includes the element. In addition, it should be noted that the scope of the method and the apparatus in the embodiments of this application is not limited to performing functions in an illustrated or discussed sequence, and may further include performing functions in a basically simultaneous mariner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (such as a ROM/RAM, a hard disk, or an optical disc), and includes several instructions for instructing a terminal (which may be a mobile phone, a computer, a server, an air conditioner, a network side device, or the like) to perform the methods described in the embodiments of this application.

The embodiments of this application are described above with reference to the accompanying drawings, but this application is not limited to the above specific implementations, and the above specific implementations are only illustrative and not restrictive. Under the enlightenment of this application, those of ordinary skill in the art can make many forms without departing from the purpose of this application and the protection scope of the claims, all of which fall within the protection of this application.

1. A PUSCH repetition method, comprising:
prohibiting, by a network side device, configuring enabling of a physical uplink shared channel (PUSCH) uplink transmission skipping function for a terminal, and configuring PUSCH repetitions of more than X times; or
when the terminal is configured to enable the PUSCH uplink transmission skipping function and is configured to perform PUSCH repetitions of more than X times, prohibiting, by the network side device, a resource conflict between scheduled or configured first uplink control information (UCI) and a first transmission opportunity, wherein the first transmission opportunity is the last Y transmission opportunities among K transmission opportunities;
wherein:
the PUSCH repetition comprises the K transmission opportunities;
K, X, and Y are all positive integers;
K≥Y; and
K is greater than or equal to 2.

2. The PUSCH repetition method according to claim 1, wherein:
the PUSCH repetition comprises type A repetition, and the network side device configures enabling of the PUSCH uplink transmission skipping function for the terminal, and configures PUSCH repetitions less than or equal to X times or configures a time domain resource allocation list where transmission opportunities for transmission repetition are less than or equal to X; or
the PUSCH repetition comprises type B repetition, and the network side device configures enabling of the PUSCH uplink transmission skipping function for the terminal, and configures a time domain resource allocation list less than or equal to X.

3. The PUSCH repetition method according to claim 2, further comprising:
sending first information, wherein the first information is used to schedule or configure first UCI transmission, the first UCI has a resource conflict with a second transmission opportunity, and the second transmission opportunity is any one of the K transmission opportunities; and
receiving a PUSCH of the second transmission opportunity, wherein the PUSCH of the second transmission opportunity comprises the first UCI.

4. The PUSCH repetition method according to claim 1, wherein:
the PUSCH repetition comprises type A repetition, and the network side device configures enabling of the PUSCH uplink transmission skipping function for the terminal, and configures PUSCH repetitions of more than X times; or
the PUSCH repetition comprises type A repetition, the network side device configures enabling of the PUSCH uplink transmission skipping function for the terminal, and configures a time domain resource allocation list greater than X, and the terminal is scheduled to perform PUSCH repetitions greater than X times; or
the PUSCH repetition comprises type B repetition, the network side device configures enabling of the PUSCH uplink transmission skipping function for the terminal, configures a time domain resource allocation list greater than X, and the terminal is scheduled to perform PUSCH repetitions greater than X times.

5. The PUSCH repetition method according to claim 4, further comprising:
sending first information, wherein the first information is used to schedule or configure first UCI transmission, the first UCI has a resource conflict with a second transmission opportunity, and the second transmission opportunity is any one of the first (K-Y) transmission opportunities of the K transmission opportunities; and
receiving a PUSCH of the second transmission opportunity, wherein the PUSCH of the second transmission opportunity comprises the first UCI.

6. The PUSCH repetition method according to claim 3, wherein the first UCI comprises at least one of the following:
hybrid automatic repeat request acknowledgment (HARQ-ACK), channel state information (CSI), or a scheduling request (SR).

7. A network side device, comprising: a memory storing a computer program; and a processor coupled to the memory and configured to execute the computer program to perform operations comprising:
prohibiting, by the network side device, configuring enabling of a physical uplink shared channel (PUSCH) uplink transmission skipping function for a terminal, and configuring PUSCH repetitions of more than X times; or
when the terminal is configured to enable the PUSCH uplink transmission skipping function and is configured to perform PUSCH repetitions of more than X times, prohibiting, by the network side device, a resource conflict between scheduled or configured first uplink control information (UCI) and a first transmission opportunity, wherein the first transmission opportunity is the last Y transmission opportunities among K transmission opportunities;
wherein:
the PUSCH repetition comprises the K transmission opportunities;
K, X, and Y are all positive integers;
K≥Y; and
K is greater than or equal to 2.

8. The network side device according to claim 7, wherein:
the PUSCH repetition comprises type A repetition, and the network side device configures enabling of the PUSCH uplink transmission skipping function for the terminal, and configures PUSCH repetitions less than or equal to X times or configures a time domain resource allocation list where transmission opportunities for transmission repetition are less than or equal to X; or
the PUSCH repetition comprises type B repetition, and the network side device configures enabling of the PUSCH uplink transmission skipping function for the terminal, and configures a time domain resource allocation list less than or equal to X.

9. The network side device according to claim 8, wherein the operations further comprise:
sending first information, wherein the first information is used to schedule or configure first UCI transmission, the first UCI has a resource conflict with a second transmission opportunity, and the second transmission opportunity is any one of the K transmission opportunities; and
receiving a PUSCH of the second transmission opportunity, wherein the PUSCH of the second transmission opportunity comprises the first UCI.

10. The network side device according to claim 7, wherein:
the PUSCH repetition comprises type A repetition, and the network side device configures enabling of the PUSCH uplink transmission skipping function for the terminal, and configures PUSCH repetitions of more than X times; or
the PUSCH repetition comprises type A repetition, the network side device configures enabling of the PUSCH uplink transmission skipping function for the terminal, and configures a time domain resource allocation list greater than X, and the terminal is scheduled to perform PUSCH repetitions greater than X times; or
the PUSCH repetition comprises type B repetition, the network side device configures enabling of the PUSCH uplink transmission skipping function for the terminal, configures a time domain resource allocation list greater than X, and the terminal is scheduled to perform PUSCH repetitions greater than X times.

11. The network side device according to claim 10, wherein the operations further comprise:
sending first information, wherein the first information is used to schedule or configure first UCI transmission, the first UCI has a resource conflict with a second transmission opportunity, and the second transmission opportunity is any one of the first (K-Y) transmission opportunities of the K transmission opportunities; and
receiving a PUSCH of the second transmission opportunity, wherein the PUSCH of the second transmission opportunity comprises the first UCI.

12. The network side device according to claim 9, wherein the first UCI comprises at least one of the following:
hybrid automatic repeat request acknowledgment (HARQ-ACK), channel state information (CSI), or a scheduling request (SR).

13. A non-transitory computer-readable storage medium, storing a computer program, wherein the computer program, when executed by a processor of a network side device, causes the processor to perform operations comprising:
prohibiting, by the network side device, configuring enabling of a physical uplink shared channel (PUSCH) uplink transmission skipping function for a terminal, and configuring PUSCH repetitions of more than X times; or
when the terminal is configured to enable the PUSCH uplink transmission skipping function and is configured to perform PUSCH repetitions of more than X times, prohibiting, by the network side device, a resource conflict between scheduled or configured first uplink control information (UCI) and a first transmission opportunity, wherein the first transmission opportunity is the last Y transmission opportunities among K transmission opportunities;
wherein:
the PUSCH repetition comprises the K transmission opportunities;
K, X, and Y are all positive integers;
K≥Y; and
K is greater than or equal to 2.

14. The non-transitory computer-readable storage medium according to claim 13, wherein:
the PUSCH repetition comprises type A repetition, and the network side device configures enabling of the PUSCH uplink transmission skipping function for the terminal, and configures PUSCH repetitions less than or equal to X times or configures a time domain resource allocation list where transmission opportunities for transmission repetition are less than or equal to X; or
the PUSCH repetition comprises type B repetition, and the network side device configures enabling of the PUSCH uplink transmission skipping function for the terminal, and configures a time domain resource allocation list less than or equal to X.

15. The non-transitory computer-readable storage medium according to claim 14, wherein the operations further comprise:
sending first information, wherein the first information is used to schedule or configure first UCI transmission, the first UCI has a resource conflict with a second transmission opportunity, and the second transmission opportunity is any one of the K transmission opportunities; and
receiving a PUSCH of the second transmission opportunity, wherein the PUSCH of the second transmission opportunity comprises the first UCI.

16. The non-transitory computer-readable storage medium according to claim 13, wherein:
the PUSCH repetition comprises type A repetition, and the network side device configures enabling of the PUSCH uplink transmission skipping function for the terminal, and configures PUSCH repetitions of more than X times; or
the PUSCH repetition comprises type A repetition, the network side device configures enabling of the PUSCH uplink transmission skipping function for the terminal, and configures a time domain resource allocation list greater than X, and the terminal is scheduled to perform PUSCH repetitions greater than X times; or
the PUSCH repetition comprises type B repetition, the network side device configures enabling of the PUSCH uplink transmission skipping function for the terminal, configures a time domain resource allocation list greater than X, and the terminal is scheduled to perform PUSCH repetitions greater than X times.

17. The non-transitory computer-readable storage medium according to claim 16, wherein the operations further comprise:
sending first information, wherein the first information is used to schedule or configure first UCI transmission, the first UCI has a resource conflict with a second transmission opportunity, and the second transmission opportunity is any one of the first (K-Y) transmission opportunities of the K transmission opportunities; and
receiving a PUSCH of the second transmission opportunity, wherein the PUSCH of the second transmission opportunity comprises the first UCI.

18. The non-transitory computer-readable storage medium according to claim 15, wherein the first UCI comprises at least one of the following:
hybrid automatic repeat request acknowledgment (HARQ-ACK), channel state information (CSI), or a scheduling request (SR).
